(19) United States
(12) Patent Application Publication
(10) Pub. No.: US 2017/0287491 A1
(43) Pub. Date: Oct. 5, 2017

(54) Unlocking Method and Electronic Device

(71) Applicants: Le Holdings (Beijing) Co., Ltd., Beijing (CN); LE SHI ZHI XIN ELETRONIC TECHNOLOGY (TIANJIN) LIMITED, Tianjin (CN)

(72) Inventors: Fei Yao, Tianjin (CN); Zhengxi Hu, Tianjin (CN)

(21) Appl. No.: 15/245,160

(22) Filed: Aug. 23, 2016

Related U.S. Application Data
(63) Continuation of application No. PCT/CN2016/089537, filed on Jul. 10, 2016.

(30) Foreign Application Priority Data
Mar. 30, 2016 (CN) 2016101957118

(51) Int. Cl. G10L 17/22; G10L 25/51; G10L 15/18; G10L 17/06; G10L 17/02

(52) U.S. Cl. CPC G10L 17/22; G10L 17/06; G10L 17/02; G10L 15/1815; G10L 25/51

(57) ABSTRACT

An unlocking method and electronic device are provided. The unlocking method includes: receiving input sound information; and when a voiceprint feature of the sound information is within a preset voiceprint feature range of a corresponding function or application, unlocking the function or the application. The embodiments of the present disclosure enable a particular user group unable to operate a locked function or application, and enable other user groups to unlock a corresponding function or application in at least one unlocking manner, thereby more fully meeting a requirement of a user on encryption of a function or an application of a terminal.

### CROSS-REFERENCE TO RELATED APPLICATIONS

The present application is a continuation of PCT application No. PCT/CN2016/089537 submitted on Jul. 10, 2016, and claims priority to Chinese Patent Application No. 201610195711.8, filed with the Chinese Patent Office on Mar. 30, 2016 and entitled “UNLOCKING METHOD AND APPARATUS AND INTELLIGENT TV,” which is incorporated herein by reference in its entirety.

### TECHNICAL FIELD

The present application relates to the field of information technologies, and in particular, to an unlocking method and electronic device.

### BACKGROUND

With the development of information technologies, more terminals already have an open platform, and can load an operation system and implement more functions. For example, an intelligent TV enables a user to autonomously install and uninstall various types of applications (APP) when watching common TV content, thereby bringing rich personal experience to the user. The following describes existing defects of the current type of terminals with the intelligent TV as an example.

Currently, with more and more types of APPs installable on an intelligent TV, an APP management solution similar to a computer desktop also emerges, that is, multiple TV desktops are obtained by means of dividing according to types of APPs. As shown in FIG. 1, a carousel desktop, an on-demand desktop, a search desktop, and a game desktop or the like are obtained by means of dividing. However, compared with a computer, an intelligent TV is closer to family life and is a typical household appliance shared by all family members. Therefore, a child can also use more APPs, for example, game APPs, by the intelligent TV. Therefore, rich Internet experience brought by the intelligent TV may make a child addicted to games, which is certainly not expected by parents.

In view of this, currently, there are also many solutions of locking a function or an application in an intelligent TV, for example, a “parent lock,” so that when a TV desktop is turned to, a function or an application corresponding to the lock can be enabled only when a correct password is entered. However, on one hand, if knowing a password, a child can still unlock a locked function or application; on the other hand, an adult needs to enter a password to unlock when operating the function or the application. However, once the adult forgets the password, a related function or application cannot be normally used.

In conclusion, an encryption function of an existing terminal such as a TV cannot fully meet requirements of users.

### SUMMARY

The present application provides an unlocking method and electronic device, which can unlock a set function or application by voiceprint features of different users, so that a particular user group cannot operate a locked function or application.

On a first aspect, an embodiment of the present application provides an unlocking method. The unlocking method includes: receiving input sound information; and when a voiceprint feature of the sound information is within a preset voiceprint feature range of a corresponding function or application, unlocking the function or the application.

On a second aspect, an embodiment of the disclosure further provides a non-volatile computer storage medium, which stores computer executable instructions, where the computer executable instructions are used to execute any of the foregoing unlocking methods of the disclosuree.

On a third aspect, an embodiment of the disclosure further provides an electronic device, including: at least one processor; and a memory, where the memory stores a program that can be executed by the at least one processor, and the instructions are executed by the at least one processor, so that the at least one processor can execute any of the foregoing unlocking methods of the disclosure.

The unlocking method and electronic device provided by the present disclosure can enable a particular user group (children) unable to operate a locked function or application of a terminal, and enable other user groups (adults) able to unlock a corresponding function or application in at least one unlocking manner, thereby more fully meeting a requirement of a user on encryption of a function or an application of the terminal.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a schematic diagram of an existing TV desktop;

FIG. 2 is a schematic flowchart of an unlocking method according to Embodiment 1 of the present disclosure;

FIG. 3 is a schematic structural diagram of an unlocking apparatus according to Embodiment 1 of the present disclosure;

FIG. 4 is a schematic flowchart of an unlocking method according to Embodiment 2 of the present disclosure;

FIG. 5 is a schematic structural diagram of an unlocking apparatus according to Embodiment 2 of the present disclosure;

FIG. 6 is a schematic flowchart of an unlocking method according to Embodiment 3 of the present disclosure;

FIG. 7 is a schematic structural diagram of an unlocking apparatus according to Embodiment 3 of the present disclosure;

FIG. 8 is a schematic flowchart of unlocking a TV desktop provided in an application example of the present disclosure;

FIG. 9 is a schematic diagram of an interface in which a TV desktop is unlocked in an application example of the present disclosure; and

FIG. 10 is a schematic structural diagram of hardware of an electronic device for executing an unlocking method provided by Embodiment 5 of the present disclosure.

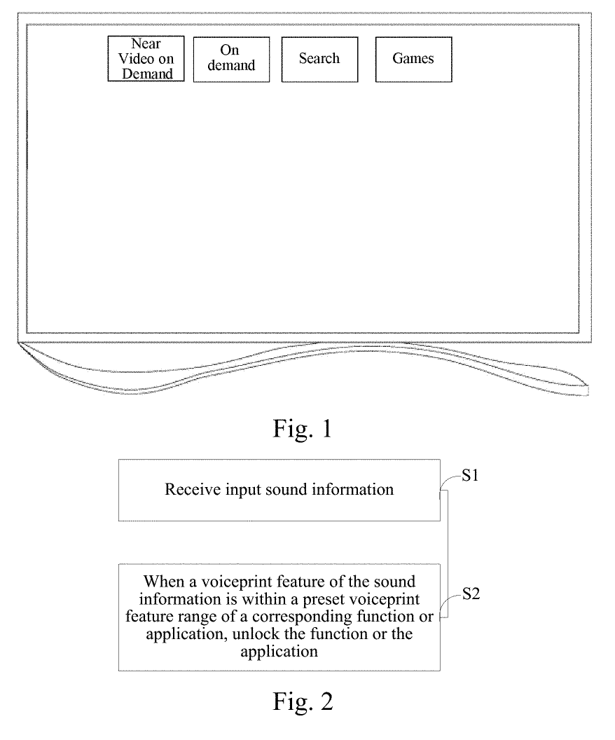

Description of Reference Numerals of The Drawings

| | | | |
|---|---|---|---|
| 1 | Information Receiving Module | 2 | First Unlocking Module |
| 3 | Second Unlocking Module | 4 | Priority Configuration |
| | | | Module |

### DETAILED DESCRIPTION

To make the objectives, technical solutions, and advantages of the disclosure clearer, hereinafter, the technical solutions of the disclosure will be clearly and completely described by implementation manners with reference to the accompanying drawings in the embodiments of the disclosure. Apparently, the described embodiments are a part rather than all of the embodiments of the disclosure.

A voiceprint is a sound wave spectrum carrying speech information displayed by an electric acoustic instrument. Modern scientific studies show that, a voiceprint has specificity and relative stability, which is similar to a fingerprint. Each person almost has a unique voiceprint feature in a speech process. Voiceprint recognition is a process of identifying an identity of a speaker from a section of voice by using characteristics of a voice print, and mainly includes a voiceprint modeling step, a feature extraction step, and a voiceprint comparison step. Because algorithms involved in each step all are relatively fully disclosed in prior art, in embodiments of the present disclosure, a voiceprint recognition algorithm that has been disclosed in the prior art can be directly used. Therefore, in view of a problem that an existing encryption function of a TV desktop cannot fully meet a requirement of a user, the embodiments of the present disclosure, based on characteristics of a voiceprint, provide a solution of granting an authority of unlocking a corresponding function or application to a user by identifying a voiceprint feature of the user (which mainly refers to a voiceprint spectrum feature).

In addition, an objective of the embodiments of the present disclosure is to unlock functions and applications involved in various types of terminals (a computer, an intelligent TV, and the like), that is, the directed function or application is a function or application having been locked completely. For a locking process, related references can be referred to, and details are no more described herein.

It should be noted that, to clearly describe the unlock solutions in the present disclosure, the following provides a description with unlocking a TV desktop as an application scenario, but the present disclosure is not limited to the application scenario.

Based on the foregoing basic principle of voiceprint recognition, the present disclosure mainly has the following several implementation manners.

### Embodiment 1

As shown in FIG. 2, this embodiment provides an unlocking method. The unlocking method includes:

Step S1: receiving input sound information.

The sound information can be input to a TV by a peripheral sound acquisition apparatus such as a microphone, a mobile phone, etc. Alternatively, a sound acquisition apparatus may be integrated into a TV, to obtain sound information of a user. In addition, a main control system of a TV should be able to control enabling and disabling of various sound acquisition apparatuses, so as to avoid recording other noise when a user does not intend to input a sound.

Step S2: when a voiceprint feature of the sound information is within a preset voiceprint feature range of a corresponding function or application, unlock the function or the application.

In this embodiment, a corresponding function or application is preferably a function or an application configured on a TV desktop. After the sound information input by the user for unlocking the corresponding function or application is received, a voiceprint feature of the sound needs to be further identified, to determine whether the user has an authority to unlock the TV desktop.

In this embodiment, a specific unlocking scenario is: only an adult user is allowed to unlock a particular TV desktop (for example, a game desktop), and a child is prevented from operating the particular TV desktop. Therefore, the unlocking scenario in this embodiment mainly relates to two types of voiceprint features, that is, voiceprint features of adults and voiceprint features of children. Therefore, during voiceprint recognition, it is only required to differentiate voiceprints of adults from voiceprints of children, and there is no need to render a result of the voiceprint recognition precise to a specific person.

It can be known according to achievements of existing voiceprint recognition technologies that, there is a very obvious difference between voiceprint features of adults and those of children. Therefore, a threshold for differentiating an adult voiceprint from a child voiceprint can be set. A voiceprint feature is extracted from the received input sound information, and then the extracted voiceprint feature is compared with the set threshold, thereby determining whether a user that intends to unlock is an adult or a child. If the user that intends to unlock is an adult, a preset unlocking program is started, and a locked desktop is unlocked; if the user that intends to unlock is a child, an unlocking program is not started.

Therefore, in step S2, the preset voiceprint feature range of the corresponding function or application is determined according to the difference (which mainly refers to a difference in voiceprint spectrum features) between voiceprint features of adults and those of children. Specifically, voiceprint features exceeding the foregoing set threshold may be used as the voiceprint feature range in step S2, so that the voiceprint feature range corresponds to an adult voiceprint. Therefore, only an adult can unlock the set TV desktop.

In this embodiment, for a particular unlocking scenario, a voiceprint feature range for unlocking a corresponding function or application is determined by a threshold for differentiating voiceprint features of an adult voiceprint from those of a child voiceprint, which not only can achieve an objective that only an adult can unlock a corresponding function or application, but also can avoid precise voiceprint recognition for each person, thereby simplifying complexity of a conventional voiceprint recognition algorithm, which helps to improve unlocking efficiency.

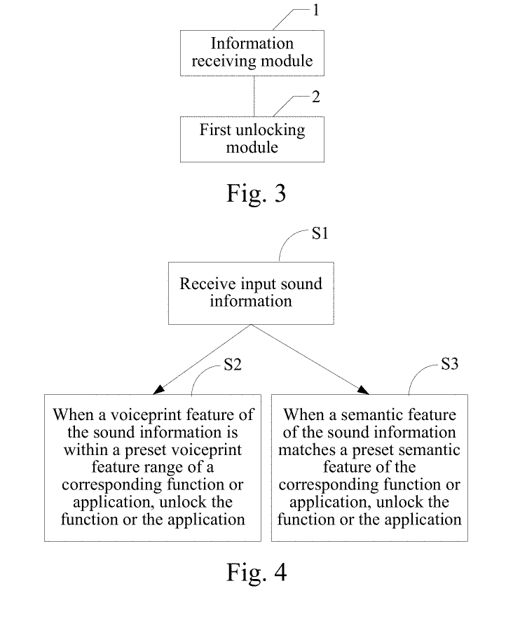

Based on an invention idea the same as that of the foregoing unlocking method in this embodiment, this embodiment further provides an unlocking apparatus. As shown in FIG. 3, the unlocking apparatus includes: an information receiving module 1 configured to receive input sound information; and a first unlocking module 2 configured to unlock a corresponding function or application when a voiceprint feature of the sound information is within a preset voiceprint feature range of the function or the application.

A specific implementation process of the unlocking apparatus is the same as or similar to the unlocking method in this embodiment, and details are not described herein again.

### Embodiment 2

As shown in FIG. 4, compared with Embodiment 1, a corresponding unlocking method in this embodiment further includes:

Step S3: when a semantic feature of the sound information matches a preset semantic feature of the corresponding function or application, unlock the function or the application.

An unlocking method based on a semantic feature is a most common voice unlocking method in the field. For example, for starting (that is, unlocking) of an electronic device, a voice password of two Chinese characters “kai ji” for unlocking may be preset and recorded. When needing to use the electronic device, a user inputs sound information. The electronic device then analyzes whether semantics of the sound information includes a word matching the preset two Chinese characters “kai ji,” if yes, the electronic device is started; if no, the electronic device is not started.

The unlocking method based on a voiceprint feature in Embodiment 1 can implement that only an adult can unlock a TV page and has strong practicability. However, the unlocking method application based on a semantic feature is used more widely than the unlocking method based on a voiceprint feature. Moreover, the unlocking method based on a semantic feature is more stable for a current feature identification technology. Therefore, to avoid a problem of an unlock failure when a malfunction occurs during voiceprint feature identification, based on Embodiment 1, in this embodiment, the unlocking method based on a semantic feature is used as redundancy of the unlocking method based on a voiceprint feature, to ensure normal implementation of an unlocking function.

In this embodiment, preferably, after the sound information is input in step S1, different interfaces are invoked to respectively perform step S2 and step S3, where which interface is selected may be autonomously determined by the user. Therefore, it can be avoided that, after the sound information is input, both the unlocking based on a voiceprint feature and the unlocking method based on a semantic feature are performed, so that an execution process is out of order, thereby affecting normal implementation of an unlocking function.

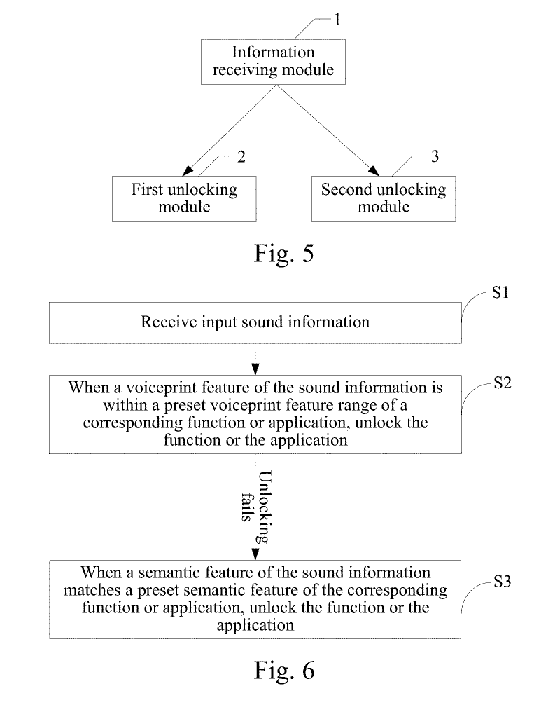

Based on an invention idea the same as that of the foregoing unlocking method in this embodiment, as shown in FIG. 5, this embodiment further provides an unlocking apparatus. Based on the unlocking apparatus in Embodiment 1, the unlocking apparatus further includes a second unlocking module 3, configured to unlock the corresponding function or application when a semantic feature of the sound information matches a preset semantic feature of the function or the application.

A specific implementation process of the unlocking apparatus is the same as or similar to the unlocking method in this embodiment, and details are not described herein again.

### Embodiment 3

For Embodiment 2, when the unlocking method based on a semantic feature is implemented by an interface different from that of the unlocking method based on a voiceprint feature, in an application scenario of Embodiment 1, if knowing a voice password for unlocking, a child may skip the unlocking method based on a voiceprint feature and directly unlock a locked desktop by the unlocking method based on a semantic feature.

Therefore, based on Embodiment 2, in an unlocking method in this embodiment, a priority of the voiceprint feature in the sound information is configured to be higher than that of the semantic feature in the sound information, that is, after the sound information is acquired, unlocking based on a voiceprint feature has the priority. As shown in FIG. 6, after step S1 is performed, because a priority of unlocking based on a voiceprint feature is higher than that of unlocking based on a semantic feature, step S2 ought to be first performed. If step S2 is successfully performed, a locked TV desktop is unlocked. Otherwise, step S3 is considered to be performed.

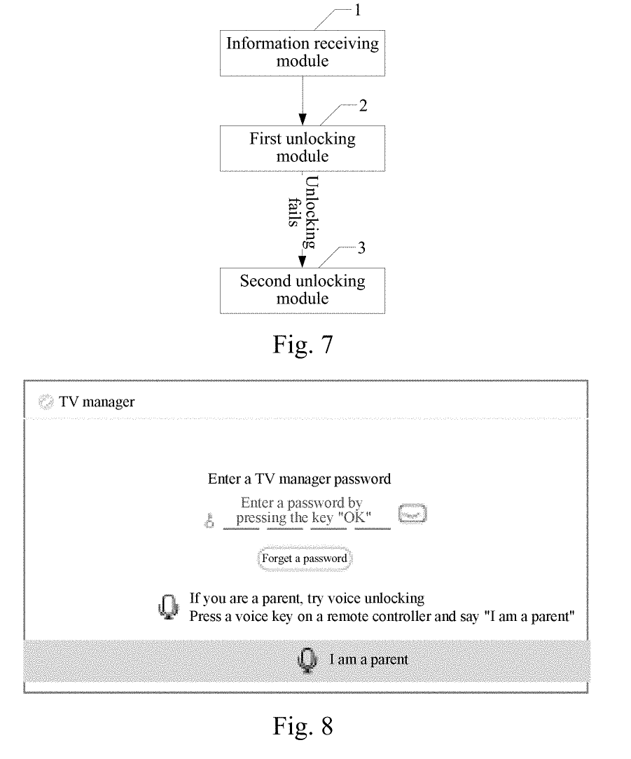

Correspondingly, based on an invention idea the same as that of the unlocking method in this embodiment, this embodiment also provides an unlocking apparatus. As shown in FIG. 7, compared with the unlocking apparatus in Embodiment 2, the unlocking apparatus further includes: a priority configuration module 4 configured to configure an unlocking priority of the first unlocking module 2 to be higher than that of the second unlocking module 3. Moreover, under control of the priority configuration module 4, the first unlocking module 2 is first invoked, and when unlocking by the first unlocking module 2 fails, the second unlocking module 3 is invoked to perform unlocking.

Further, for the unlocking methods involved in Embodiment 1, Embodiment 2, and Embodiment 3, besides the unlocking method based on a voiceprint feature and the unlocking method based on a semantic feature, the function or the application may be further unlocked by entering, with a keyboard, a preset password for unlocking a corresponding function or application of a TV desktop, where the password can be entered by a keyboard of a mobile phone, a keyboard of a remote controller, or the like. The unlocking method based on keyboard entry is mainly used as redundancy of the unlocking method based on a voiceprint feature and the unlocking method based on a semantic feature in this embodiment, so as to implement triple redundancy of unlocking. In addition, the unlocking method based on keyboard entry is an unlocking solution most common in the field. Therefore, a specific implementation process is not described in detail herein.

Further, based on the unlocking set with triple redundancy, the unlocking method in this embodiment of the present disclosure further includes: when an error occurs in unlocking, displaying corresponding prompt information to the user. For example, when a voiceprint feature of the user cannot be identified, “Cannot unlock. Please select other unlocking manners” or similar words are displayed on an intelligent TV, to prompt the user to change the unlocking method.

Correspondingly, the unlocking apparatuses involved in Embodiment 1, Embodiment 2, and Embodiment 3 may further include a third unlocking module (not shown in the figure) configured to unlock, with a keyboard, the function or the application by entering a preset password for unlocking a corresponding function or application, so as to implement an unlocking mechanism of triple redundancy. In addition, based on this, an information prompt mechanism in which corresponding prompt information is presented to the user when an error occurs in unlocking may be further set. A function of the information prompt mechanism may also be implemented by a main control system of the intelligent TV.

In addition, other embodiments of the present disclosure further provides an intelligent TV. The intelligent TV has the unlocking apparatus according to any one of Embodiment 1, Embodiment 2, or Embodiment 3.

With reference to the technical solutions embodied by the foregoing embodiments of the present disclosure, the following describes, by a specific application example, how to perform voiceprint unlocking in a scenario in which a “parent lock” is set. In an unlocking scenario in the application example, only voiceprint feature identification is performed without semantic feature identification. Moreover, a voiceprint recognition interface provided by a voice SDK and a voice input interface as shown in FIG. 8 may be used to help the user to unlock by identifying a voice.

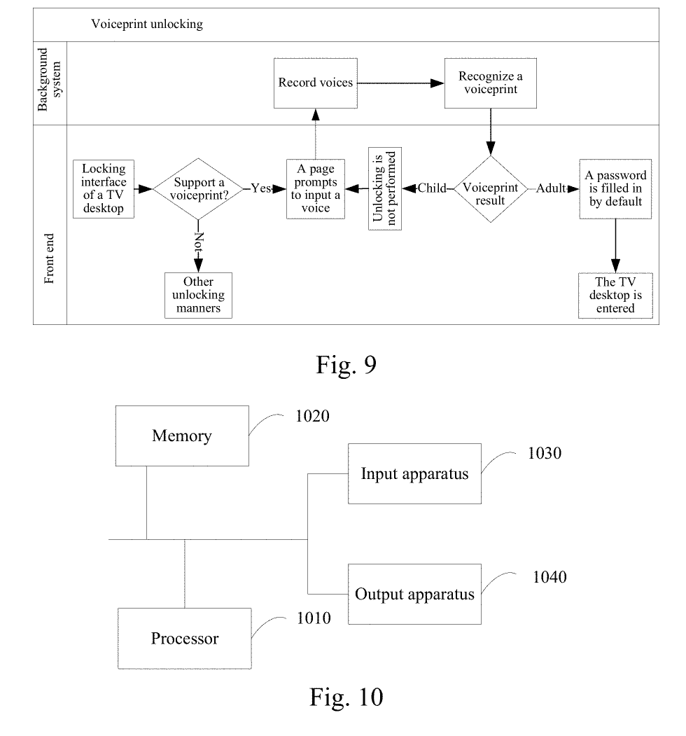

FIG. 9 shows a process in which a user performs voiceprint unlocking in the application example. On a front end of a TV, a locking interface of a locked TV desktop is entered, and it is determined whether the voiceprint unlocking is supported. If not supported, original voice (semantic) unlocking logic or logic of a password by a keyboard entry is remained; if supported, a page prompt pops up on the TV desktop, for example, prompting a parent to hold a remote controller and say “unlock the parent lock,” and meanwhile, a background system starts to record voices input by the user, and after recording starts to recognize a voice print. If a voiceprint result is a child, unlocking is not performed; or if a voiceprint result is an adult, a password is filled in by default, and the TV desktop is automatically entered, thereby completing an entire unlocking process.

In conclusion, the unlocking method and apparatus and the intelligent TV provided in the embodiments of the present disclosure, may enable a particular user group (children) unable to operate a locked TV desktop, and enable other user groups (adults) to unlock a corresponding function or application in at least one unlocking manner, thereby more fully meeting a requirement of a user on encryption of a function or an application of a terminal.

### Embodiment 4

Embodiment 4 of the disclosure provides a non-volatile computer storage medium, which stores computer executable instructions, where the computer executable instructions can execute the unlocking method of any of the foregoing method embodiments of the disclosure.

### Embodiment 5

FIG. 10 is a schematic structural diagram of hardware of an electronic device for executing an unlocking method provided by Embodiment 5 of the disclosure. As shown in FIG. 10, the device includes:

one or more processors 1010 and a memory 1020, with one processor 1010 as an example in FIG. 10.

An electronic device for executing the unlocking method may further include: an input apparatus 1030 and an output apparatus 1040.

The processor 1010, the memory 1020, the input apparatus 1030, and the output apparatus 1040 can be connected by means of a bus or in other manners, with a connection by means of a bus as an example in FIG. 10.

As a non-volatile computer readable storage medium, the memory 1020 can be used to store non-volatile software programs, non-volatile computer executable programs and modules, for example, program instructions/module corresponding to the unlocking method in the embodiments of the disclosure (for example, information receiving module 1, first unlocking module 2 and second unlocking module 3 shown in FIGS. 3, 5 and 7). The processor 1010 executes various functional applications and data processing of the server, that is, implements the unlocking method of the foregoing method embodiments, by running the non-volatile software programs, instructions, and modules stored in the memory 1020.

The memory 1020 may include a program storage area and a data storage area, where the program storage area may store an operating system and at least one application needed by function; the data storage area may store data created according use of the unlocking apparatus, and the like. In addition, the memory 1020 may include a high-speed random access memory, and also may include a non-volatile memory, such as at least one disk storage device, flash storage device, or other non-volatile solid-state storage devices. In some embodiments, the memory 1020 optionally includes memories remotely disposed with respect to the processor 1010, and the remote memories may be connected, via a network, to the unlocking apparatus. Examples of the foregoing network include but are not limited to: the Internet, an intranet, a local area network, a mobile communications network, and a combination thereof.

The input apparatus 1030 can receive entered digit or character information, and generate key signal inputs relevant to user setting and functional control of the unlocking apparatus. The output apparatus 1040 may include a display device, for example, a display screen, etc.

The one or more modules are stored in the memory 1020, and execute the unlocking method in any one of the foregoing method embodiments when being executed by the one or more processors 1010.

The foregoing product can execute the method provided in the embodiments of the disclosure, and has corresponding functional modules for executing the method and beneficial effects. The method provided in the embodiments of the disclosure can be referred to for technical details that are not described in detail in the embodiment.

The electronic device in the embodiment of the disclosure exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the disclosure, rather than limiting thereon. Although the disclosure has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the disclosure.

What is claimed is:

1. An unlocking method applied in a terminal, wherein the unlocking method comprises:
receiving input sound information; and
when a voiceprint feature of the sound information is within a preset voiceprint feature range of a corresponding function or application, unlocking the function or the application.

2. The unlocking method according to claim 1, wherein the preset voiceprint feature range is determined according to a threshold for differentiating voiceprint features of an adult voiceprint from those of a child voiceprint.

3. The unlocking method according to claim 1, wherein the unlocking method further comprises:
when a semantic feature of the sound information matches a preset semantic feature of the corresponding function or application, unlocking the function or the application.

4. The unlocking method according to claim 2, wherein the unlocking method further comprises:
when a semantic feature of the sound information matches a preset semantic feature of the corresponding function or application, unlocking the function or the application.

5. The unlocking method according to claim 3, wherein in the sound information, a priority of the voiceprint feature is higher than that of the semantic feature.

6. The unlocking method according to claim 4, wherein in the sound information, a priority of the voiceprint feature is higher than that of the semantic feature.

7. The unlocking method according to claim 3, wherein the unlocking method further comprises:
unlocking the function or the application by entering, with a keyboard, a preset password for unlocking a corresponding function or application.

8. The unlocking method according to claim 4, wherein the unlocking method further comprises:
unlocking the function or the application by entering, with a keyboard, a preset password for unlocking a corresponding function or application.

9. A non-volatile computer storage medium, stored with computer executable instructions that, when executed by an electronic device, cause the electronic device to:
receive input sound information; and
unlock a corresponding function or application when a voiceprint feature of the sound information is within a preset voiceprint feature range of the function or the application.

10. The non-volatile computer storage medium according to claim 9, wherein the preset voiceprint feature range of the corresponding function or application is determined according to a threshold for differentiating voiceprint features of an adult voiceprint from those of a child voiceprint.

11. The non-volatile computer storage medium according to claim 9, wherein the electronic device is further caused to:
unlock the function or the application when a semantic feature of the sound information matches a preset semantic feature of the corresponding function or application.

12. The non-volatile computer storage medium according to claim 10, wherein the electronic device is further caused to:
unlock the function or the application when a semantic feature of the sound information matches a preset semantic feature of the corresponding function or application.

13. The non-volatile computer storage medium according to claim 9, wherein the electronic device is further caused to:
configure an unlocking priority of the first unlocking module to be higher than an unlocking priority of the second unlocking module.

14. An electronic device, including:
at least one processor; and
a memory in communication connection with the at least one processor, wherein
the memory stores instructions that can be executed by the at least one processor,
wherein execution of the instructions by the said at least one processor causes the at least one processor to:
receive input sound information; and
when a voiceprint feature of the sound information is within a preset voiceprint feature range of a corresponding function or application, unlock the function or the application.

15. The electronic device according to claim 14, wherein the preset voiceprint feature range of the corresponding function or application is determined according to a threshold for differentiating voiceprint features of an adult voiceprint from those of a child voiceprint.

16. The electronic device according to claim 14, wherein the at least one processor is further caused to:
when a semantic feature of the sound information matches a preset semantic feature of the corresponding function or application, unlock the function or the application.

17. The electronic device according to claim 15, wherein the at least one processor is further caused to:
when a semantic feature of the sound information matches a preset semantic feature of the corresponding function or application, unlock the function or the application.

18. The electronic device according to claim 14,wherein the at least one processor is further caused to:
configure an unlocking priority of the first unlocking module to be higher than an unlocking priority of the second unlocking module.
